(19) United States
(12) Patent Application Publication
(10) Pub. No.: US 2006/0254593 A1
(43) Pub. Date: Nov. 16, 2006

(54) Full-face mask

(76) Inventor: Eric Chang, Ta Ya Hsiang (TW)

Correspondence Address: CHRISTIE, PARKER & HALE, LLP, PO BOX 7068, PASADENA, CA, 91109-7068, US

(21) Appl. No.: 11/128,906

(22) Filed: May 13, 2005

(51) Int. Cl. A62B 18/08; A62B 18/02; A62B 23/02

(52) U.S. Cl. 128/206.24; 128/207.13; 128/205.25; 128/206.21; 128/206.26; 128/206.12; 128/206.18; 128/206.28; 128/207.12

(57) ABSTRACT

A full-face mask includes a gas conduit, a membrane extending around the gas conduit and connected to one end of the gas conduit, a cap wall extending around and connected to the membrane and having a face-sealing edge opposite to the membrane, and at least one head attachment strap connected to the cap wall. The membrane is stretchable outward or foldable inward when there is a change in pressure inside the cap wall, or when the gas conduit is moved relative to the cap wall.

### BACKGROUND OF THE INVENTION

1. Field of the Invention

The invention relates to a full-face mask, more particularly to a full-face mask with a resilient stretchable membrane.

2. Description of the Related Art

Full-face masks are commonly used in the treatment of respiratory conditions and sleep disorders by delivering a flow of breathable gas to assist a patient's respiration. A full-face mask typically includes a mask body connected to a gas conduit that delivers gas into the mask body, and a plurality of tension straps to mount the mask body on a patient's face. The mask body is usually semi-rigid and has a face-contact portion that comprises a soft, resilient elastomeric material which may conform to various facial contours. The mask body is normally secured to the patient's head by the tension straps. The tension straps function to pull the mask body against the patient's face to achieve a gas-tight seal therebetween so that the gas from the mask body is delivered to the wearer's nasal passages and throat. However, there are drawbacks in the conventional full-face masks. For example, the mask body may be dislodged due to accidental displacement of the gas conduit or the gas supply line, thereby breaking the seal between the mask body and the wearer's face. Another drawback is that the face contacting portion may apply excessive pressure to the wearer's face, resulting in discomfort and possibly skin irritation due to the tension straps which constantly pull and release the mask body against the wearer's face when there is a change in pressure inside the mask body. In U.S. Pat. No. 6,701,927, there is disclosed a full-face cushion that comprises a substantially triangularly shaped frame from which a membrane extends. The frame has a scalloped edge by which the cushion is affixed to a mask body to form a full-face mask. The membrane has an aperture into which the wearer's nose is received. The member is spaced away from the rim of the frame, and the outer surface thereof is of substantially the same shape as the rim. Respective notches receive the bridge of the wearer's nose. The wearer's nose and lips are received through the aperture into the chamber within the mask body. A seal-forming portion thus contacts both the surface of the wearer's nose and a portion of the wearer's face in the region between the bottom lip and the chin, and around the sides and over the bridge of the nose. The shape of the seal-forming portion is particularly suited to effectively seal the difficult region of the facial contour that is the crease between the sides of the nose and the face.

Although the aforesaid full-face mask serves the purpose of lowering mask-to-face pressure and provides greater comfort to the wearer, the pull-and-release phenomena still exist in use. Moreover, the problem of mask dislodgement caused by accidental displacement of the gas conduit still remains unresolved.

### SUMMARY OF THE INVENTION

Therefore, the object of the present invention is to provide a full-face mask that can overcome the aforesaid drawbacks associated with the prior art.

According to the present invention, there is provided a full-face mask which comprises a gas conduit, a membrane extending around the gas conduit and connected to one end of the gas conduit, a cap wall which extends around and which is connected to the membrane and which has a face-sealing edge opposite to the membrane, and at least one head attachment strap connected to the cap wall. The membrane is stretchable outward or foldable inward when there is a change in pressure inside the cap wall, or when the gas conduit is moved relative to the cap wall.

### BRIEF DESCRIPTION OF THE DRAWINGS

Other features and advantages of the present invention will become apparent in the following detailed description of the preferred embodiments with reference to the accompanying drawings, of which:

FIG. 1 is an assembled perspective view of the preferred embodiment of a full-face mask according to the present invention;

FIG. 2 is a partly schematic sectional view of the preferred embodiment of the full-face mask attached to the wearer's face;

FIG. 3 is an enlarged view of an encircled portion of FIG. 2;

FIG. 4 is a partly schematic sectional view of the preferred embodiment of the full-face mask illustrating that a membrane of a mask cap thereof is stretched outward;

FIG. 5 is a partly schematic sectional view of the preferred embodiment of the full-face mask illustrating that the membrane deforms as a gas conduit is moved; and

FIG. 6 is a front view of a modified preferred embodiment of the full-face mask that has a cap wall covering only a nose region.

### DETAILED DESCRIPTION OF THE PREFERRED EMBODIMENTS

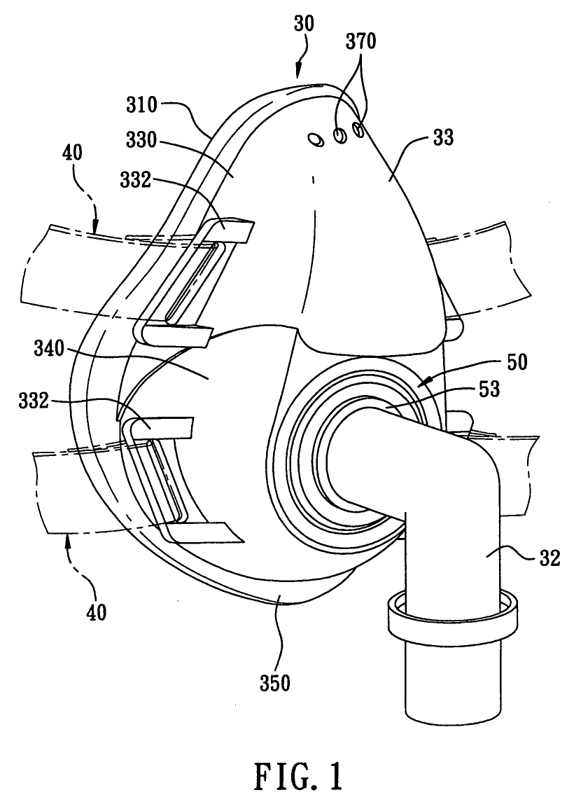

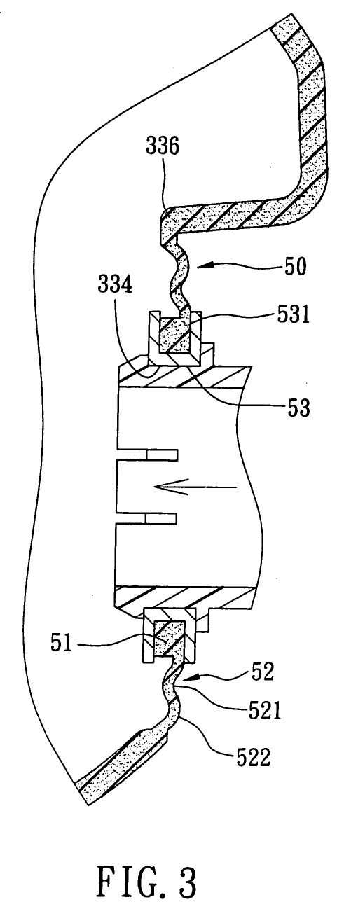

Referring to FIGS. 1 to 4, the preferred embodiment of a full-face mask according to the present invention is shown to be connected to a gas supply unit 60 that is well known in the art, and includes a mask cap 30, a pair of head attachment straps 40 and a gas conduit 32.

The mask cap 30 includes a cap wall 33 which includes a face-sealing edge 310, a nose region 330, a mouth region 340, a chin region 350, and a plurality of vent openings 370 disposed in the nose region 330. The face-sealing edge 310 is made of a resilient material for sealing contact with the wearer's face to prevent leakage of air from the mask cap 30.

A membrane 50 is provided in the mouth region 340 and is connected to a membrane connection end 336 of the cap wall 33. In this embodiment, the cap wall 33 is connected directly to and molded integrally with the membrane 50 as a one-piece construction.

The gas conduit 32 has one end connected to the membrane 50 and another end 320 connected to the gas supply unit 60. An air chamber 360 is confined by the cap wall 33 and the membrane 50 between the face-sealing edge 310 of the cap wall 33 and the end of the gas conduit 32 which is connected to the membrane 50.

The mask cap 30 further includes a sleeve ring 53 that is made of a rigid material and that defines an air inlet hole 334. The sleeve ring 53 is sleeved around the gas conduit 32 and has a U-shaped cross-section so that it defines an annular recess 531 around the air inlet hole 334.

The membrane 50 includes a thick marginal edge 51 fixedly received in the annular recess 531 of the sleeve ring 53, and a deformable thin region 52 connected to and extending around the thick marginal edge 51. The thin region 52 is connected to the membrane connection end 336 of the cap wall 33 which is opposite to the face-sealing edge 310. The thin region 52 is formed with at least one substantially annular crease, specifically, two annular creases 521, 522 between the membrane connection end 336 and the thick marginal edge 51.

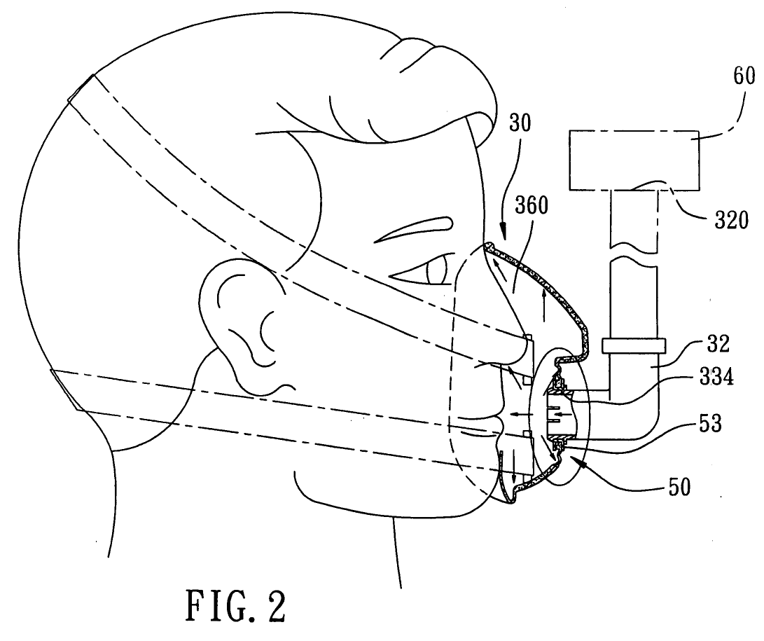

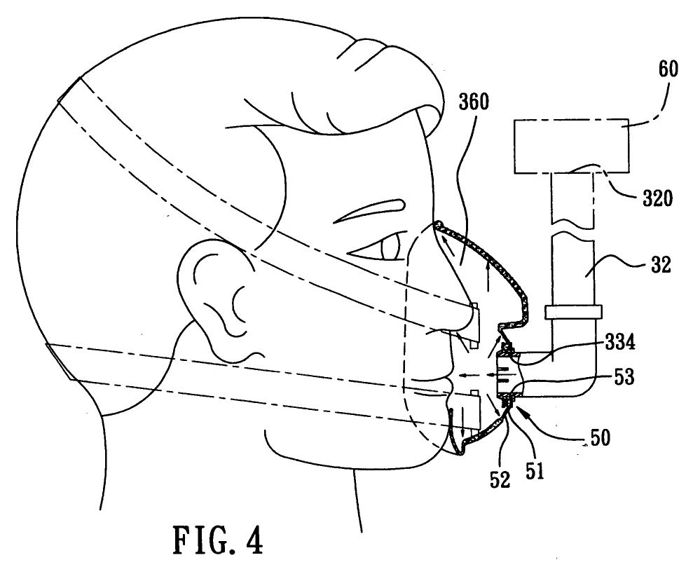

Due to the creases 521, 522 of the thin region 52 of the membrane 50, the membrane 50 is stretchable outward or foldable inward when there is a change in pressure inside the mask cap 30, or when the gas conduit 32 is moved relative to the mask cap 30. The mask cap 30 further includes at least one pair of strap engaging members 332. In particular, the mask cap 30 includes two pairs of the strap engaging members 332, which are connected respectively to two head attachment straps 40. In use of the full-face mask according to the present invention, the gas conduit 32 is connected to the gas supply unit 60, whereas the mask cap 30 is attached to the head of the wearer through the head attachment straps 40. When the pressure inside the mask cap 30 increases, the membrane 50 is stretched outward as shown in FIG. 4. When the pressure decreases, the membrane 50 is folded inward as shown in FIG. 2. The deformation of the membrane 50 as such will not affect the tension of the head attachment straps 40 so that the problem of discomfort that may be caused to the wearer's face can be eliminated efficiently. This is because the membrane 50 is farther from the face-sealing edge 310 than the strap engaging members 332 and thus is outside a region of the cap wall 33 between the face-sealing edge 310 and the strap engaging members 332, unlike the membrane which is disclosed in U.S. Pat. No. 6,701,927 and which is provided between the strap engaging members and a face-contacting end of the full-face mask thereof.

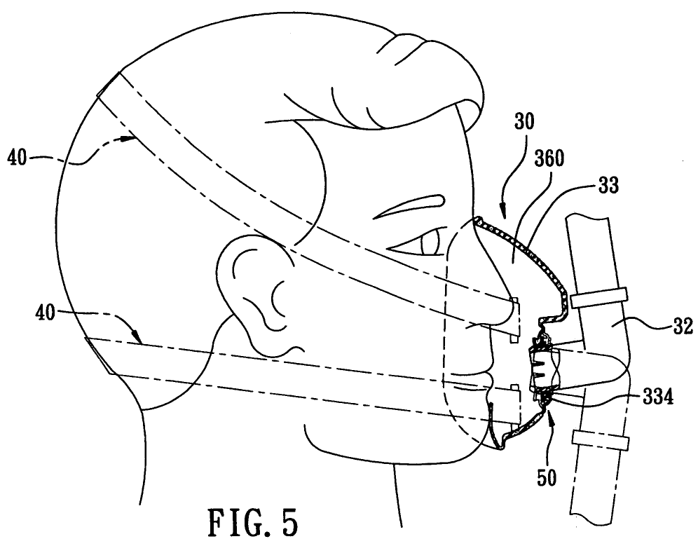

In addition, since the deformable membrane 50 in the present invention is directly connected to the gas conduit 32, the gas conduit 32 is permitted to turn or bend relative to the mask cap 30 as shown in FIG. 5. Therefore, when the gas conduit 32 is subjected to external forces caused by the movement of the wearer, or accidental hitting of the gas conduit 32, the membrane 50 will deform and absorb the external forces so that such forces will not cause soreness or discomfort to the wearer.

While the membrane 50 is molded integrally with the cap wall 33 in this embodiment, the present invention should not be limited thereto. The membrane 50 of this invention may be molded integrally with the gas conduit 32.

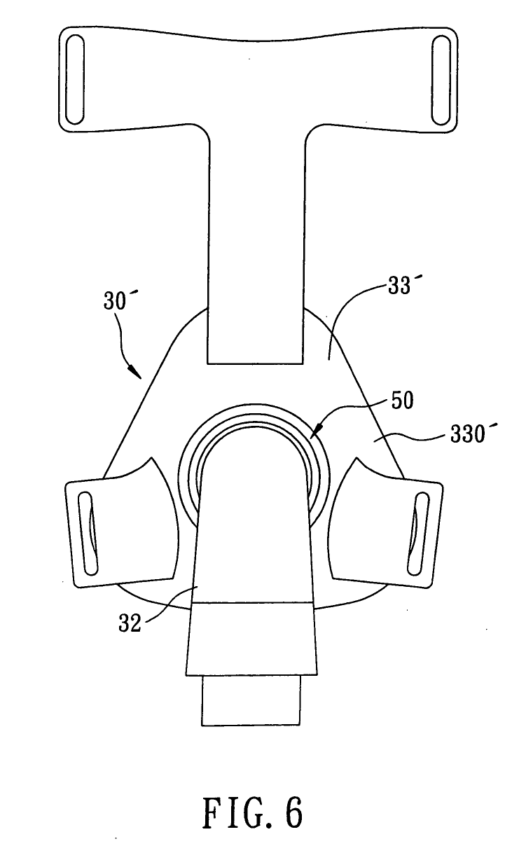

FIG. 6 is a modified preferred embodiment of a full-face mask including a mask cap 30′ with a cap wall 33′ that covers only a nose region 330′. In this embodiment, the entire volume of the mask cap 30′ is reduced as compared to the mask cap 30 of the previous embodiment. As the membrane 50 is provided in the nose region 330′ and is connected to the gas conduit 12, this embodiment will provide the same effect as the previous embodiment.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. (canceled)

2. A full-face mask adapted for masking a wearer's face and for supplying air to the wearer, comprising:
a gas conduit;
a membrane extending around said gas conduit and connected to one end of said gas conduit;
a cap wall which extends around and which is connected to said membrane and which has a face-sealing edge opposite to said membrane;
a sleeve ring defining an air inlet hole and sleeved directly around said gas conduit, said membrane including a thick marginal edge fixed directly to said sleeve ring, and a deformable thin region connected to and extending around said thick marginal edge, said cap wall being connected directly to said thin region, said cap wall and said membrane being molded integrally as a one-piece construction; and
at least one head attachment strap connected to said cap wall,
wherein said membrane is stretchable outward or foldable inward when there is a change in pressure inside said cap wall, or when said gas conduit is moved relative to said cap wall.

3. The full-face mask as claimed in claim 2, wherein said sleeve ring has a substantially U-shaped cross-section and defines an annular recess, said thick marginal edge being fitted in said annular recess.

4. The full-face mask as claimed in claim 2, wherein said cap wall further includes a nose region, a mouth region, a chin region, and a vent opening disposed in said nose region, said membrane being provided in said mouth region.

5. The full-face mask as claimed in claim 4, wherein said cap wall further includes a membrane connection end opposite to said face-sealing edge and connected to said thin region, said thin region having at least one substantially annular crease between said membrane connection end and said thick marginal edge.

6. The full-face mask as claimed in claim 5, wherein said mask cap further includes at least one pair of strap engaging members provided on said cap wall and connected to said head attachment strap.

7. (canceled)
